(19) United States
(12) Patent Application Publication
(10) Pub. No.: US 2008/0073564 A1
(43) Pub. Date: Mar. 27, 2008

(54) Device for cleaning electrostatic chuck of ion implanter

(75) Inventor: Kyung-Tae Mun, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd., Suwon-si (KR)

(21) Appl. No.: 11/522,872

(22) Filed: Sep. 18, 2006

(30) Foreign Application Priority Data
May 16, 2006 (KR) 2006-0043733

(51) Int. Cl. G01F 23/00

(52) U.S. Cl. 250/441.11

(57) ABSTRACT

A device for cleaning an electrostatic chuck in an ion implanter includes a power supplier for generating a hot wire voltage, an electrostatic chuck for sucking a wafer, and a hot wire installed in the interior of the electrostatic chuck and driven by the hot wire voltage supplied from the power supplier for emitting heat from the electrostatic chuck.

### CROSS-REFERENCE TO RELATED APPLICATION

This application claims priority from Korean Patent Application 10-2006-0043733 filed on May 16, 2006, the disclosure of which is hereby incorporated by reference herein in its entirety.

### BACKGROUND OF INVENTION

1. Technical Field

The present disclosure relates to ion implanters, and more particularly, to an electrostatic chuck cleaning device capable of removing particles sucked onto the electrostatic chuck to prevent a wafer drop in an ion implantation process of semiconductor manufacturing equipment.

2. Description of the Related Art

In general, an ion implantation process involves introducing impurities such as P-type impurities having three valence electrons (e.g., boron, aluminum, indium), or N-type impurities having five valence electrons (e.g., antimony, phosphor, arsenic), into a semiconductor crystal at its surface, so as to modify its electronic properties.

An ion implanter for performing the above ion implantation process is described in U.S. Pat. No. 5,475,618. The above-mentioned ion implanter is widely used with highly integrated semiconductor devices because the density of impurities may be controlled within a range of about 10E14 to about 10E18 Atom/cm³ in manufacturing these semiconductor devices. In addition, the density of the impurities is easier to control using ion implantation than when using other impurities implantation techniques such as, for example, a diffusion technique. Thus, with ion implantation, the depth of ion implantation obtained may be more precise in comparison to other implantation techniques.

FIG. 1 is a block diagram of a conventional ion implanter.

Referring to FIG. 1, the configuration of conventional ion implanter will be described as follows.

In FIG. 1, an ion source chamber 10 generates an ion beam. A beam line chamber 12 forms a beam of implantation ions from the generated ions. An end station 14 performs an ion implantation of the ion beam to a wafer. First and second loadlock chambers 22 and 24 send a wafer for an ion implantation to the end station 14 or take an ion implantation-completed wafer out of the end station 14. First and second isolation valves 18 and 20 individually isolate the end station 14 from the first and second loadlock chamber 22, 24. First and second turbo pumps 30 and 32 pump to maintain a high vacuum in the first and second loadlock chambers 22 and 24. Third and fourth isolation valves 23 and 25 are each installed between the first and second loadlock chamber 22, 24 and the first and second turbo pump 30, 32, and individually isolate the first, second loadlock chamber 22, 24 from the first, second turbo pump 30, 32. A vacuum pump 38 assists a vacuum pumping of the first and second turbo pump 30, 32 and performs a pumping for a vacuum in the first, second loadlock chamber 22, 24. First and second roughing valves 26 and 28 are installed on a vacuum line connected to the first and second loadlock chamber 22, 24, and are switched to form the first and second loadlock chamber 22, 24 as a vacuum state from an atmospheric state. Third and fourth roughing valves 32 and 34 opens or closes a vacuum line of the first and second turbo pumps 30, 32. A cryo-pump 16 performs a pumping so as to uniformly maintain the pressure of the high vacuum in the end station 14. A fifth roughing valve 36 is connected to the vacuum pump 38 and is switched to enable a vacuum line of the first and second turbo pump 30, 32 and the cryo pump 16 rough.

Operation of the conventional ion implanter will be described referring to FIG. 1, as follows.

To send wafers loaded in first and second loadlock chamber 22, 24 to end station 14 having a high-vacuum state, the first and second loadlock chamber 22, 24 having an atmospheric state should be changed to a high-vacuum state which is the same as the end station 14.

To first enable the first loadlock chamber 22 to be in a high-vacuum state, a controller(not shown) opens a first roughing valve 26 installed on vacuum line, and closes a second roughing valve 28, and closes a fifth roughing valve 36. Then, the controller drives the vacuum pump 38 to lower the pressure of the first loadlock chamber 22 having an atmospheric state to, e.g., 10³ Torr. The vacuum pump 38 cannot lower the pressure of the first loadlock chamber 22 to the same pressure as the end station 14 and thus the first turbo pump 30 is used to maintain the high-vacuum of the first loadlock chamber 22. When the pressure of the first loadlock chamber 22 is lowered to 10³ Torr, the controller closes the first roughing valve 26, and opens third isolation valve 23 and third and fifth roughing valves 32 and 36. The controller drives first turbo pump 30 and performs a pumping so that the pressure of the first loadlock chamber 22 becomes, for example, 10⁻⁴ Torr. Then, when the pressure of the first loadlock chamber 22 becomes the same as that of the end station 14, first isolation valve 18 opens and so wafers loaded in the first loadlock chamber 22 are sent into the end station 14. While an ion implantation to the wafer is performed in the end station 14, cryo pump 16 is driven to uniformly maintain pressure of the end station 14.

Further, to enable second loadlock chamber 24 to be in a high-vacuum state, controller(not shown) opens a second roughing valve 28 installed on vacuum line, and closes a first roughing valve 26, and closes fifth roughing valve 36. Then, the controller drives vacuum pump 38 to lower pressure of the second loadlock chamber 24 having an atmospheric state to, e.g., 10⁻³ Torr. The vacuum pump 38 cannot lower pressure of the second loadlock chamber 24 to the same pressure as the end station 14, and thus the second turbo pump 32 is used to maintain a high-vacuum of the second loadlock chamber 24. When the pressure of the second loadlock chamber 24 is lowered to 10⁻³ Torr, the controller closes the second roughing valve 28, and opens fourth isolation valve 25 and fourth and fifth roughing valves 34 and 36. The controller drives second turbo pump 32 and performs a pumping so that pressure of the second loadlock chamber 24 becomes, for example, 10⁴ Torr. Then, when the pressure of the second loadlock chamber 24 becomes the same as that of the end station 14, second isolation valve 20 opens and so wafers loaded in the second loadlock chamber 24 are sent into the end station 14. While an ion implantation to the wafer is performed in the end station 14, cryo pump 16 is driven to uniformly maintain the pressure of the end station 14. The first to fifth roughing valves 26, 28, 32, 34 and 36 may be solenoid valves.

FIGS. 2A and 2B are perspective views an electrostatic chuck is installed in end station 14. Referring to FIGS. 2A and 2B, an electrostatic chuck 40 is configured to clamp a wafer, and an electrostatic chuck driver 42 is configured to move the electrostatic chuck 40 upward and downward and also to to lay down the electrostatic chuck 40 horizontally or stand it perpendicularly.

FIG. 3 illustrates a scheme to clamp a wafer of electrostatic chuck 40 shown in FIG. 2.

With reference to FIG. 3, a power supplier 50 supplies different positive power and negative power, and a wafer platen sector 52 individually receives different positive power and negative power supplied from the power supplier 50, and sucks a wafer.

When a wafer is mounted on electrostatic chuck 40, electrostatic chuck driver 42 lays down the electrostatic chuck 40 horizontally as shown in FIG. 2A, and when the wafer is mounted on the electrostatic chuck 40 by a robot, power supplier 60 of FIG. 5 individually applies different positive power A+, B+, C+ and negative power A−, B−, C− to a wafer platen sector 52. The electrostatic chuck 40 sucks and fixes the wafer. Then, the electrostatic chuck driver 42 perpendicularly stands the electrostatic chuck 40 as shown in FIG. 2B and moves it to an ion implantation position to begin an ion implantation process.

In the conventional ion implanter described above, particles generated in the ion implantation process may remain on the rear face of wafer and on the surface of the electrostatic chuck 40, and the surface of the electrostatic chuck 40 may become cool in the process and the generated particles may consequently be sucked onto the surface of electrostatic chuck 40. When particles are sucked onto the surface of an electrostatic chuck 40, the adhesive force may fall due to these particles. However, this adhesive force is needed to suck and fix the next wafer onto the electrostatic chuck 40. Consequently, as a result of the above drop in adhesive force caused by the particles, the wafer may drop down when the electrostatic chuck 40 moves to an ion implantation process position.

Thus, there is a need for a device for cleaning an electrostatic chuck in an ion implanter which prevents the above-mentioned wafer dropping difficulty which occurs in conventional ion implanter devices.

### SUMMARY OF THE INVENTION

Some exemplary embodiments of the invention provide a device for cleaning an electrostatic chuck in an ion implanter to remove particles generated on the surface of electrostatic chuck in a standby state when an ion implantation process is not being performed. The device may prevent a wafer from dropping down, caused by a weakening of the adhesive force due to the particles generated on the surface of the electrostatic chuck of the ion implanter, when a wafer of electrostatic chuck is moved for an ion implantation.

In accordance with an exemplary embodiment of the invention, a device for cleaning an electrostatic chuck in an ion implanter is provided. The device includes a power supplier for generating a hot wire voltage, an electrostatic chuck for sucking a wafer, and a hot wire installed in the interior of the electrostatic chuck and driven by the hot wire voltage supplied from the power supplier for emitting heat from the electrostatic chuck.

The device for cleaning the electrostatic chuck may further include a switch switched on/off to supply the hot wire voltage to the hot wire.

The device for cleaning the electrostatic chuck may further include a voltage controller for controlling voltage supplied from the power supplier.

The hot wire may work to float particles sucked to the surface of the electrostatic chuck through use of heat.

The device for cleaning the electrostatic chuck may further include a cryo pump for performing a pumping to discharge particles when the particles sucked to the electrostatic chuck float by the hot wire.

In accordance with an exemplary embodiment of the invention, a device for cleaning an electrostatic chuck in an ion implanter is provided. The device includes a power supplier for generating a hot wire voltage, an electrostatic chuck for sucking a wafer, a hot wire installed in the interior of electrostatic chuck and driven by the hot wire voltage supplied from the power supplier for emitting heat from the electrostatic chuck to float particles sucked to the surface of the electrostatic chuck, a switch to supply the hot wire voltage to the hot wire, and a cryo pump for performing a pumping to discharge the particles which have been sucked to the electrostatic chuck and floated by the hot wire.

### BRIEF DESCRIPTION OF THE DRAWINGS

Exemplary embodiments of the present invention can be understood in more detail from the following description taken in conjunction with the accompanying drawings, in which:

FIG. 1 is a block diagram of a conventional ion implanter;

FIGS. 2A and 2B are perspective views illustrating an electrostatic chuck installed in an end station;

FIG. 3 is a block diagram of a scheme for a clamping of wafer in an electrostatic chuck shown in FIG. 2;

FIG. 4 is a block diagram of ion implanter according to an exemplary embodiment of the invention;

FIG. 5 is a block diagram illustrating a scheme for a wafer clamping of electrostatic chuck according to an exemplary embodiment of the invention;

FIG. 6 illustrates particles sucked to the surface of electrostatic chuck; and

FIG. 7 illustrates a floating of particles from the surface of the electrostatic chuck through thermal energy.

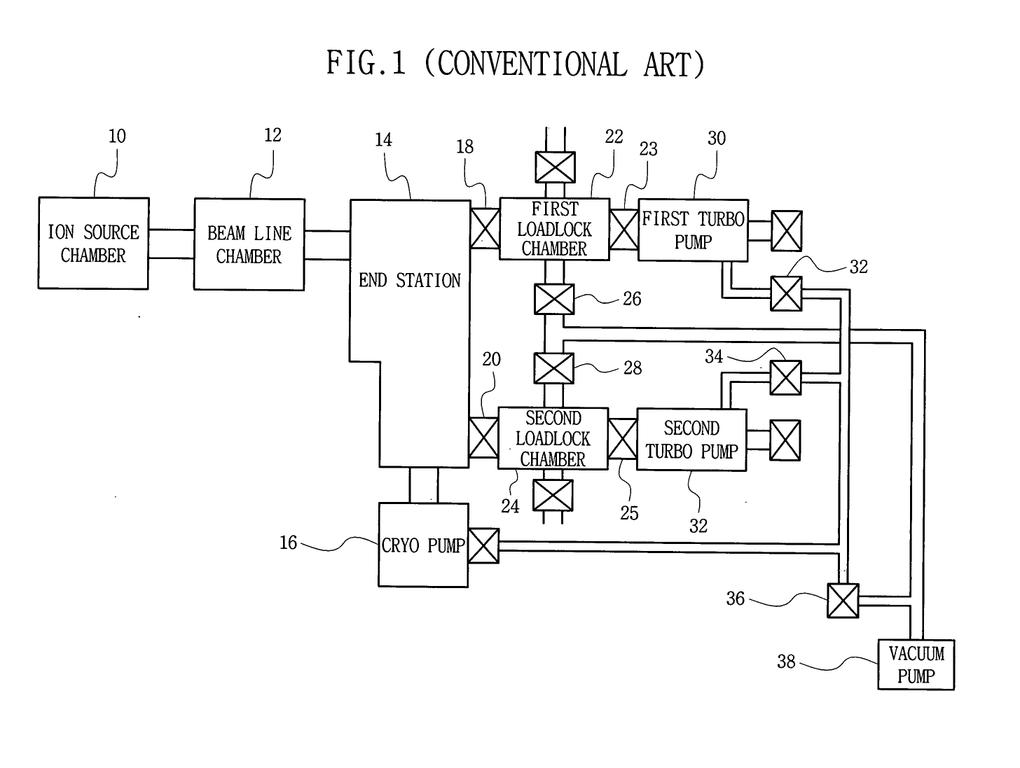

### DETAILED DESCRIPTION OF THE EXEMPLARY EMBODIMENTS

Exemplary embodiments of the present invention now will be described more fully hereinafter with reference to the accompanying drawings, in which exemplary embodiments of the invention are shown. This invention may, however, be embodied in many different forms and should not be construed as limited to the exemplary embodiments set forth herein.

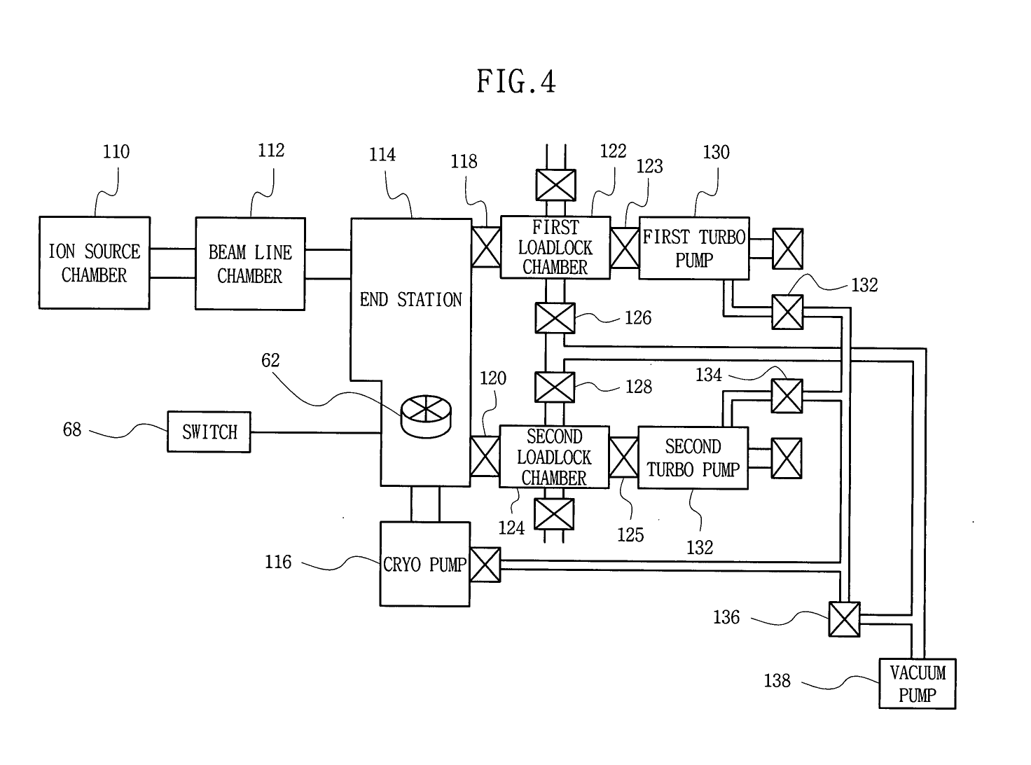

Hereinafter, exemplary embodiments of the present invention will be described in detail with reference to FIGS. 4 to 7. It will be understood by those skilled in the art that the present invention can be embodied by numerous different types and is not limited to the following described exemplary embodiments.

FIG. 4 is a block diagram of ion implanter according to an exemplary embodiment of the invention.

Referring to FIG. 4, the configuration of the ion implanter will be described as follows.

In FIG. 4, an ion source chamber 110 generates an ion beam. A beam line chamber 112 forms a beam of implantation ions in the generated ions. An end station 114 includes an electrostatic chuck 62 having a hot wire installed therein, and performs an ion implantation for a wafer put on the electrostatic chuck 62 by using the ion beam. In the end station 114, after a completion of the ion implantation, the ion implanter is placed into a standby state, wherein no wafers are placed on the electrostatic chuck 62. In the standby state, the electrostatic chuck 62 is heated to a predetermined temperature by the hot wire such that particles sucked to the surface of the electrostatic chuck 62 float by the thermal energy of the hot wire. First and second loadlock chambers 122 and 124 send a wafer for an ion implantation to the end station 114 or take an ion implantation-completed wafer out of the end station 114. First and second isolation valves 118 and 120 individually isolate the end station 114 from the first and second loadlock chamber 122, 124. First and second turbo pumps 130 and 132 pump to maintain a high vacuum in the first and second loadlock chamber 122, 124. Third and fourth isolation valves 123 and 125 are each installed between the first and second loadlock chamber 122, 124 and the first and second turbo pump 130, 132, and individually isolate the first and second loadlock chamber 122, 124 from the first and second turbo pump 130, 132. A vacuum pump 138 assists a vacuum pumping of the first and second turbo pumps 130 and 132, and performs a pumping to form a vacuum state in the first and second loadlock chambers 122 and 124. First and second roughing valves 126 and 128 are installed on a vacuum line connected to the first and second loadlock chamber 122, 124, and are switched to form a vacuum state in the first and second loadlock chamber 122 and 124 from an atmospheric state. Third and fourth roughing valves 132 and 134 open or close a vacuum line of the first and second turbo pumps 130 and 132. A cryo-pump 116 performs a pumping so as to uniformly maintain the pressure of the high vacuum in the end station 114, and performs a pumping to discharge particles when the particles sucked to the electrostatic chuck 62 of the end station 114 float by a hot wire. A fifth roughing valve 136 is connected to the vacuum pump 138 and is switched to enable a vacuum line of the first and second turbo pumps 130 and 132 and the cryo pump 116 rough.

Operation of the ion implanter according to an exemplary embodiment of the invention will be described in detail referring to FIG. 4, as follows.

To send wafers loaded within first and second loadlock chambers 122 and 124 to end station 114 having a high-vacuum state, the first and second loadlock chambers 122 and 124 having an atmospheric state should be changed to a high-vacuum state which is the same as the end station 114. To first enable the first loadlock chamber 122 in a high-vacuum state, the controller opens a first roughing valve 126 installed on the vacuum line, and closes a second roughing valve 128, and closes a fifth roughing valve 136. Then, the controller drives the vacuum pump 138 to lower the pressure of the first loadlock chamber 122 having an atmospheric state to, e.g., above 10⁻³ Torr. The vacuum pump 138 cannot lower the pressure of the first loadlock chamber 122 to the same pressure as the end station 114, and thus the first turbo pump 130 is used to maintain the high-vacuum of the first loadlock chamber 122. When pressure of the first loadlock chamber 122 is lowered to about 10⁻³ Torr, the controller closes the first roughing valve 126, and opens third isolation valve 123 and third and fifth roughing valves 132 and 136. The controller drives first turbo pump 130 and performs a pumping so that pressure of the first loadlock chamber 122 becomes, for example, about 10⁻⁴ Torr. Then, when the pressure of the first loadlock chamber 122 becomes the same as that of the end station 114, first isolation valve 118 opens and so wafers loaded in the first loadlock chamber 122 are then sent into the end station 114. While an ion implantation to the wafer is performed in the end station 114, cryo pump 116 is driven to uniformly maintain the pressure of the end station 114.

Further, to enable second loadlock chamber 124 to be in a high-vacuum state, controller opens a second roughing valve 128 installed on the vacuum line, and closes a first roughing valve 126, and closes fifth roughing valve 136. Then, the controller drives vacuum pump 138 to lower the pressure of the second loadlock chamber 124 having an atmospheric state to, e.g., about 10⁻³ Torr. The vacuum pump 138 cannot lower the pressure of the second loadlock chamber 124 to the same pressure as the end station 114, and thus the second turbo pump 132 is used to maintain the high-vacuum of the second loadlock chamber 124. When pressure of the second loadlock chamber 124 is lowered to about 10⁻³ Torr, the controller closes the second roughing valve 128, and opens fourth isolation valve 125 and fourth and fifth roughing valves 134 and 136. The controller drives second turbo pump 132 and performs a pumping so that the pressure of the second loadlock chamber 124 becomes, for example, about 10⁻⁴ Torr. Then, when the pressure of the second loadlock chamber 124 becomes the same as that of the end station 114, second isolation valve 120 opens and so wafers loaded in the second loadlock chamber 124 are sent into the end station 114. While an ion implantation to the wafer is performed in the end station 114, cryo pump 16 is driven to uniformly maintain the pressure of the end station 114. The first to fifth roughing valves 26, 28, 32, 34 and 36 may be solenoid valves. The pressure of end station 114 is uniformly maintained, and an electrostatic chuck drive upwardly elevates the electrostatic chuck 62 on which a wafer is mounted, and then stands it perpendicularly. Then, the wafer, which is fixed to and which stands on the electrostatic chuck 62, is used for an ion implantation by a beam provided from the beam line chamber 112.

When the ion implantation is completed in the end station 114, the electrostatic chuck 62 descends by the electrostatic chuck driver and then the wafer is placed horizontally and returns to first or second loadlock chamber 122, 124 by a robot. Then, when a user manipulates a switch 68, the switch 68 is switched on and a hot wire voltage is supplied to a hot wire of the electrostatic chuck 62. When the hot wire voltage is supplied to the electrostatic chuck 62, particles sucked to the surface of the electrostatic chuck 62 float within the end station 114, and the floating particles are discharged outside by a pumping of cryo pump 116.

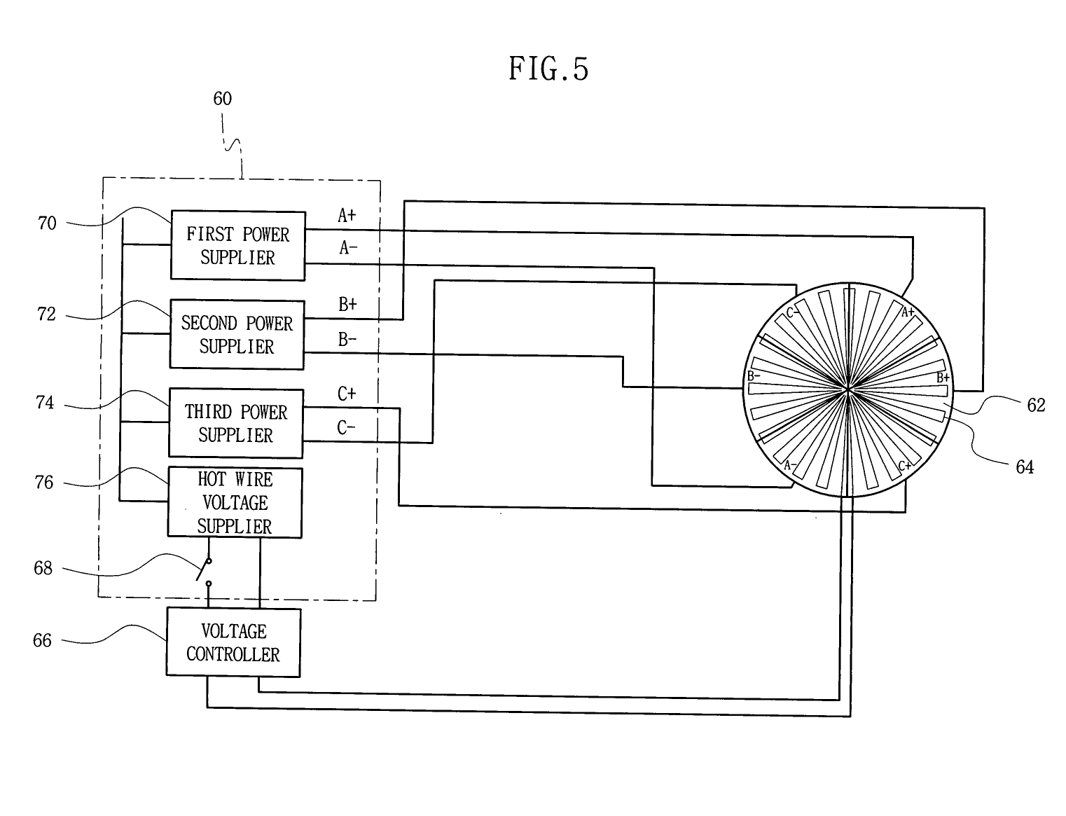

FIG. 5 is a block diagram illustrating a scheme for a wafer clamping of electrostatic chuck according to some exemplary embodiments of the invention.

With reference to FIG. 5, the scheme includes a power supplier 60 for generating and supplying different positive power and negative power and a hot wire voltage, an electrostatic chuck 62 for individually receiving the different positive power and negative power supplied from the power supplier 60 and for sucking the electrostatic chuck 62, a hot wire 64 installed in the interior of the electrostatic chuck 62 and driven by hot wire voltage supplied from the power supplier 60 to emit heat from the electrostatic chuck, a voltage controller 66 for controlling voltage supplied from the power supplier 60, and a switch 68 switched on/off to supply the hot wire voltage.

The power supplier 60 may include first to third power suppliers 70, 72 and 74, and a hot wire voltage supplier 76. The first power supplier 70 supplies a first positive power A+ and a first negative power A−. The second power supplier 72 supplies a second positive power B+ and a second negative power B−. The third power supplier 74 supplies a third positive power C+ and a third negative power C−. The hot wire voltage supplier 76 supplies a hot wire voltage to the hot wire 64.

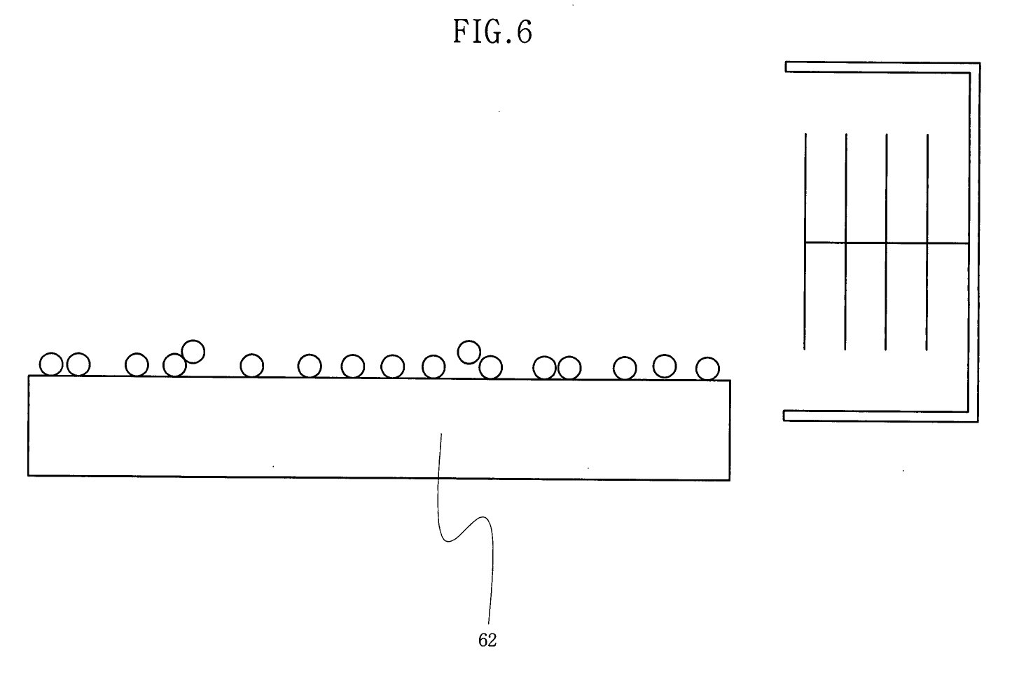

FIG. 6 illustrates a suction of particles to the surface of electrostatic chuck 62.

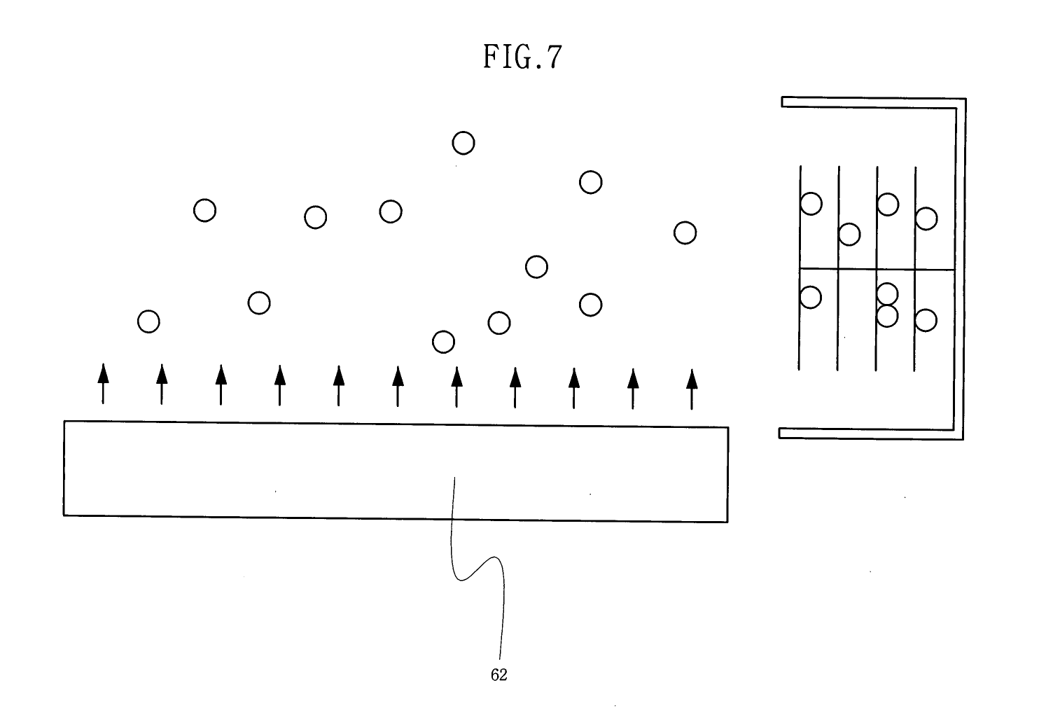

FIG. 7 illustrates a floating of particles from the surface of the electrostatic chuck 62 through thermal energy.

With reference to FIGS. 5 to 7, the operation of an exemplary embodiment of the invention will be described as follows.

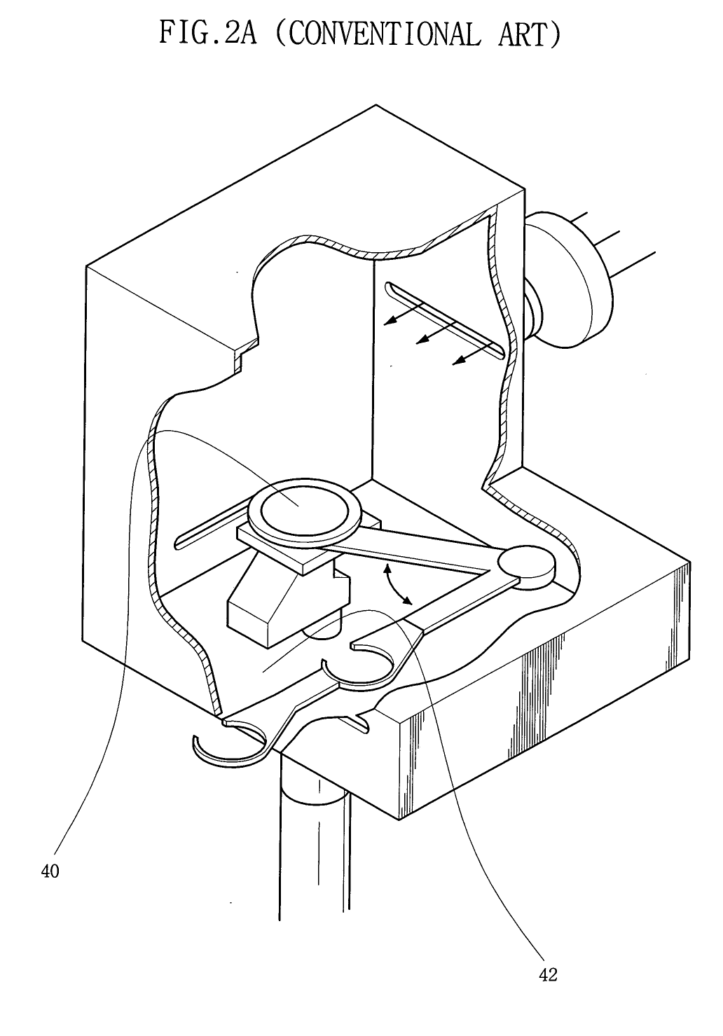

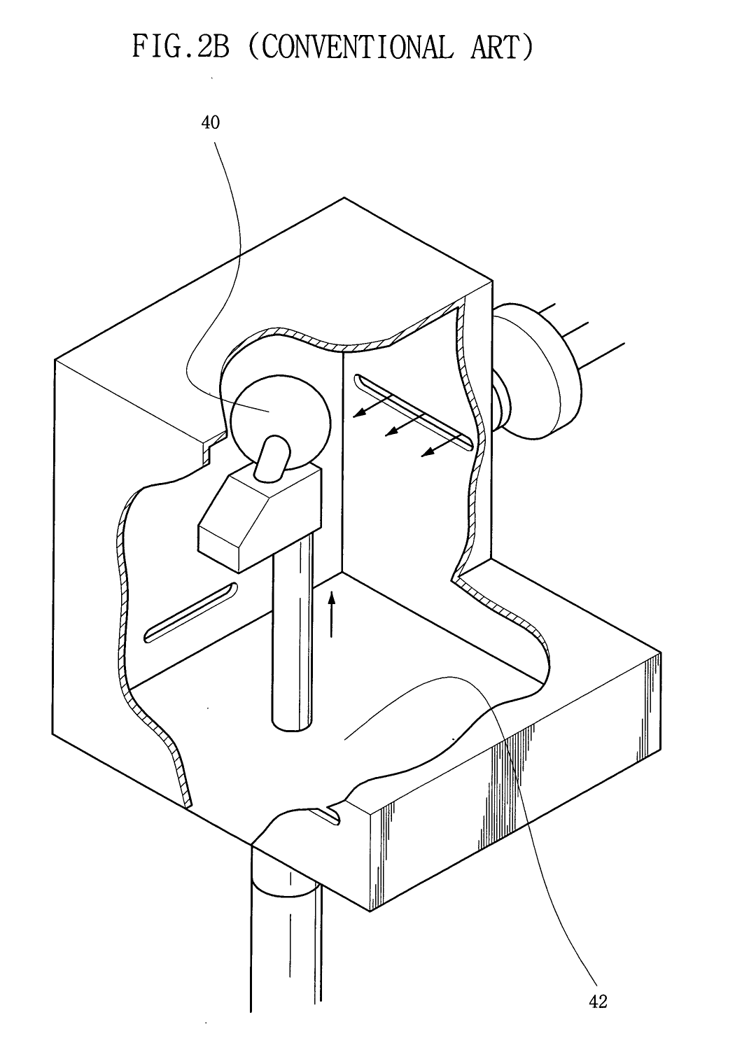

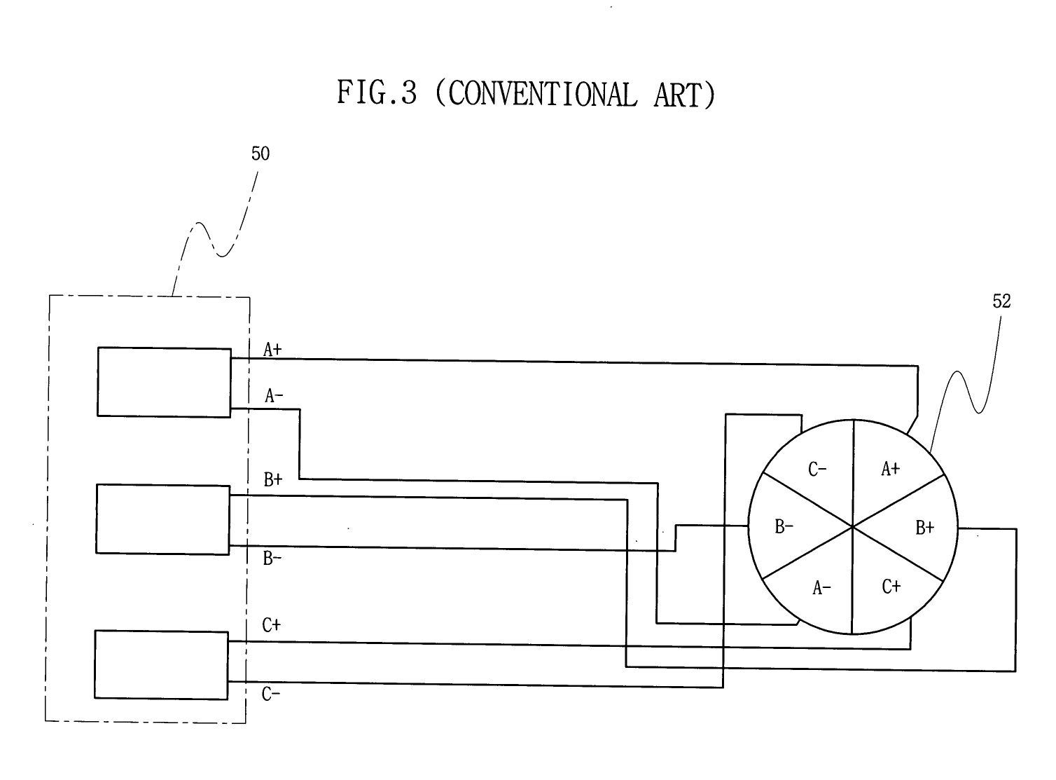

In mounting a wafer on the electrostatic chuck 62, electrostatic chuck driver 42 shown in FIG. 2A lays down the electrostatic chuck 62 horizontally, and when the wafer is mounted on the electrostatic chuck 40 by a robot, power supplier 50 of FIG. 6 individually applies different positive power A+, B+, C+ and negative power A−, B−, C− to the electrostatic chuck 62. Then, the electrostatic chuck 62 sucks the wafer to be fixed thereto. After that, the electrostatic chuck driver 42 stands the electrostatic chuck 62 perpendicularly as shown in FIG. 2B, and moves the electrostatic chuck 62 to an ion implantation position to begin an ion implantation process.

When the ion implantation is completed in the end station 114, the electrostatic chuck 62 descends by the electrostatic chuck driver 42 and then the wafer is placed horizontally and returns to first or second loadlock chamber 122, 124 by a robot. Then, when a user manipulates switch 68, the switch 68 is switched on and a hot wire voltage is supplied to a hot wire 64 of the electrostatic chuck 62. When the hot wire voltage is supplied to the electrostatic chuck 62, particles sucked to the surface of the electrostatic chuck 62 as shown in FIG. 6 float within the end station 114 as shown in FIG. 7, and the floating particles are discharged outside by a pumping of cryo pump 116. At this time, the voltage controller 66 changes a resistance value through a control knob, to control hot wire voltage supplied from the hot wire voltage supplier 76 and supply it to the hot wire 64. When the hot wire voltage is supplied to the hot wire 64, a circulation of cooling water should be able to stop in the interior of the electrostatic chuck 62. That is, a cooling valve is closed and the electrostatic chuck 62 should be in a non-cooling state.

In a state when the electrostatic chuck 62 has not been cleaned, the electrostatic chuck 62 outgases for two hours in a bake oven of about 60° C. Next, the electrostatic chuck 62 is set in the device, and at this time, about 10811 particles exist, but in test results taken after removing the particles from the surface of the electrostatic chuck 62 by heating the hot wire 64 of the electrostatic chuck 62, it was determined that the above number of particles was substantially reduced to a level of about 3023.

As described above, according to some exemplary embodiments of the invention, an implantation process of wafer is completed in an ion implanter, and the wafer returns to a loadlock chamber, then the ion implanter is then placed into a standby state. In the standby state, an electrostatic chuck is heated to a predetermined temperature by a hot wire so as to float particles sucked to the surface of the electrostatic chuck. Then, the floating particles may be discharged outside by a driving of cryo pump, thereby preventing a wafer suction fail of an electrostatic chuck or error in process caused by particles in an ion implantation.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A device for cleaning an electrostatic chuck in an ion implanter, the device comprising:
a power supplier for generating a hot wire voltage;
an electrostatic chuck for sucking a wafer; and
a hot wire installed in the interior of electrostatic chuck and driven by the hot wire voltage supplied from the power supplier for emitting heat from the electrostatic chuck.

2. The device of claim 1, further comprising a switch switched on/off to supply the hot wire voltage to the hot wire.

3. The device of claim 1, further comprising a voltage controller for controlling voltage supplied from the power supplier.

4. The device of claim 3, wherein the hot wire floats particles sucked to the surface of the electrostatic chuck through heat.

5. The device of claim 4, further comprising a cryo pump for performing a pumping to discharge the floating particles sucked to the electrostatic chuck by the hot wire.

6. A device for cleaning an electrostatic chuck in an ion implanter, the device comprising:
a power supplier for generating a hot wire voltage;
an electrostatic chuck for sucking a wafer;
a hot wire installed in the interior of the electrostatic chuck and driven by the hot wire voltage supplied from the power supplier for emitting heat from the electrostatic chuck to float particles sucked to the surface of the electrostatic chuck;
a switch to supply the hot wire voltage to the hot wire; and
a cryo pump for performing a pumping to discharge the particles which have been sucked to the electrostatic chuck and floated by the hot wire.

7. The device of claim 1, wherein the power supplier comprises a first power supplier, a second power supplier, a third power supplier and a hot wire voltage supplier.

8. The device of claim 7, wherein the first power supplier supplies a first positive power and a first negative power to the electrostatic chuck, the second power supplier supplies a second positive power and a second negative power to the electrostatic chuck and the third power supplier supplies a third positive power and a third negative power to the electrostatic chuck.

9. The device of claim 7, wherein the hot wire voltage supplier supplies the hot wire voltage to the hot wire.

10. The device of claim 6, wherein the power supplier comprises a first power supplier, a second power supplier, a third power supplier and a hot wire voltage supplier.

11. The device of claim 10, wherein the first power supplier supplies a first positive power and a first negative power to the electrostatic chuck, the second power supplier supplies a second positive power and a second negative power to the electrostatic chuck and the third power supplier supplies a third positive power and a third negative power to the electrostatic chuck.

12. The device of claim 6, further comprising a voltage controller for controlling voltage supplied from the power supplier.
